(19) United States
(12) Patent Application Publication
(10) Pub. No.: US 2026/0115943 A1
(43) Pub. Date: Apr. 30, 2026

(54) Magnetic Blade Holder

(71) Applicant: Kneadace LLC, Rehovot (IL)

(72) Inventor: Menachem Dangot, Rehovot (IL)

(21) Appl. No.: 18/668,149

(22) Filed: May 18, 2024

Related U.S. Application Data
(60) Provisional application No. 63/525,995, filed on Jul. 11, 2023.

(51) Int. Cl. B26B 1/08

(52) U.S. Cl. CPC B26B 1/08

(57) ABSTRACT

The magnetic blade holder includes a frame having a base and a cover. The magnetic blade holder further includes a blade housed within the frame. The magnetic blade holder further includes a first magnet attached to an inner side of the base; and a second magnet attached to an inner side of the cover. The cover is attached to the base when the first magnetic becomes magnetically attracted to the second magnet, and wherein the blade is housed within the frame between the base and the cover.

### CROSS-REFERENCE TO RELATED APPLICATIONS

This application claims the benefit under 35 U.S.C. 119(e) of U.S. Provisional Patent Application No. 63/525,995, filed on Jul. 11, 2023. The application is incorporated herein by reference.

### BACKGROUND OF THE INVENTION

Traditional blade holders and cutting tools often rely on mechanical mechanisms for blade retention and manipulation. While these tools serve their purpose adequately in many instances, they can be cumbersome to operate and may lack the desired precision, particularly in delicate cutting tasks such as dough scoring in baking. Additionally, manual blade holders do not provide adequate retention of the blade in order to provide safe use and storage when not in use.

Over the years, various attempts have been made to address the limitations of conventional blade holders. Some designs incorporate ergonomic features to improve user comfort, while others focus on enhancing blade stability during operation. However, a need persists for a blade holder that not only offers superior precision but also ensures ease of use across a range of cutting applications.

The present invention addresses the aforementioned shortcomings of conventional blade holders by introducing a magnetic blade holder designed for enhanced precision and ease of use. By incorporating magnetic attachment mechanisms, the blade holder offers superior stability, allowing users to perform precise cuts with ease and confidence. Additionally, ergonomic considerations ensure comfortable handling during extended use, further enhancing user experience.

### SUMMARY OF THE INVENTION

Aspects of the disclosure relate to a magnetic blade holder. The magnetic blade holder includes a frame having a base and a cover. The magnetic blade holder further includes a blade housed within the frame. The magnetic blade holder further includes a first magnet attached to an inner side of the base; and a second magnet attached to an inner side of the cover. The cover is attached to the base when the first magnetic becomes magnetically attracted to the second magnet, and wherein the blade is housed within the frame between the base and the cover.

Aspects of the disclosure further relates to a method of scoring dough using a magnetic blade holder. The method comprising providing a magnetic blade holder includes a frame having a base and a cover; a first magnet attached to an inner side of the base; and a second magnet attached to an inner side of the cover. Wherein a blade is housed within the frame between the base and the cover. The method further includes passing the blade through an opening in the frame to at least one extended position. The method further includes marking the dough with the blade to create a pattern. The method further includes retracting the blade from the at least one extended position to a retracted position.

### BRIEF DESCRIPTION OF DRAWINGS

FIG. 1 illustrates a perspective view of a first embodiment of a magnetic blade holder assembly,

FIG. 2 illustrates an exploded view of the magnetic blade holder assembly of FIG. 1,

FIG. 3 illustrates an internal view of a frame assembly base of FIG. 1,

FIG. 4 illustrates an internal view of a frame assembly cover of FIG. 1,

FIG. 5 illustrates a perspective view of a second embodiment of the magnetic blade holder assembly,

FIG. 6 illustrates an exploded view of the magnetic blade holder assembly of FIG. 5,

FIG. 7 illustrates an internal view of a frame assembly cover of FIG. 5,

FIG. 8 illustrates an internal view of a frame assembly base of FIG. 5, and

FIG. 9 illustrates a top view of a knob of the magnetic blade holder assembly of FIG. 5.

### DETAILED DESCRIPTION OF THE INVENTION

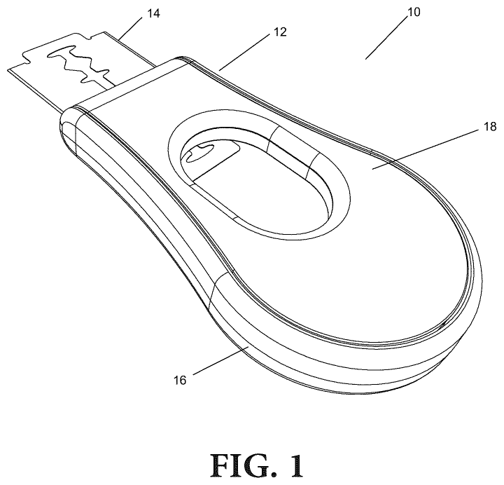

The present disclosure relates to a magnetic blade holder assembly 10. Referring to FIG. 1, a first embodiment of the magnetic blade holder assembly 10 comprises a frame assembly 12 and a blade 14.

The blade 14 is housed within the frame assembly 12 and configured to move from a retracted position 22 (not shown) to an extended position 24 (not shown). The blade may move from a plurality of extended positions 24 to a plurality of retracted positions 22 depending on the user.

The blade may be any conventional blade. For example, in some embodiments, the blade is a razor blade, or a double-edged razor blade.

The frame assembly 12 may be made of material including plastic, wood, metal, stainless steal, etc. In some embodiments, the frame assembly 12 is made of a food-safe material, such as food-safe plastics. In some embodiments, the frame assembly 12 is substantially made of polypropylene. Additionally, the frame assembly 12 may adopt any desired size and shape, including ergonomic shapes that contour to the user's hand. In some embodiments, the frame assembly 12 has a tear-drop shape. In other embodiments, the frame assembly 12 has a tapered shape with a wide bottom compared to the top. The frame assembly 12 may be heat molded into the ergonomic shape of the frame assembly 12.

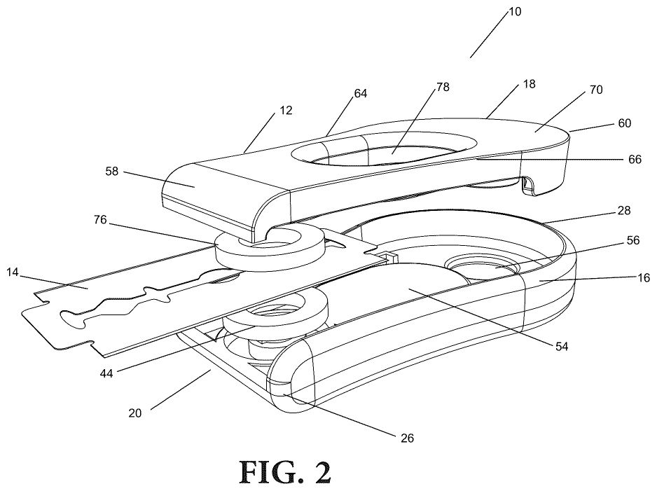

Referring to FIGS. 1 and 2, the frame assembly 12 further comprises a base 16 and a cover 18, which are magnetically attached to each other to form the frame assembly 12. When joined, an opening 20 is created in the frame assembly 12. The opening 20 is sized to fit the blade 14 and provide stability to the blade 14. The opening is sized to fit the blade 14 and to allow the blade 14 to pass through the opening 20 when it is moved from at least one retracted position 22 to an at least one extended position 24. The opening 20 is also sized to provide stability to the blade 14 when the blade 14 is in the extended positions 24.

The base 16 and cover 18 may be the same size and shape or substantially similar. In some embodiments, the base 16 and cover 18 differ in size, allowing the cover 18 to fit within the base 16 to form the overall shape of the frame assembly 12. The combination of the base 16 and the cover 18 create the overall shape of the frame assembly 12.

The base 16 and cover 18 may also be made of the same material, for example a food grade material, or a flexible plastic. In some embodiments, the base 16 and the cover 18 are both made of polypropylene. In other embodiments, the base 16 and the cover 18 are made of different materials.

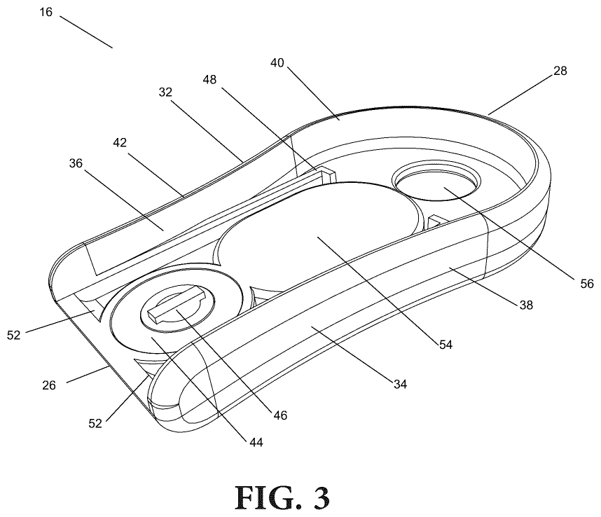

Referring to FIG. 3, the base 16 has a top 26, bottom 28, center 30, first side 32, and second side 34, as well as an inner side 36 and an outer side 38. The inner side 36 includes a wall portion 40 that extends along an outer edge 42 of the base. In some embodiments, the wall 40 portion extends along the outer edge 42 between the first side 32, bottom, 28 and second side 34 of the base 16.

The base 16 includes at least one base magnet 44 located on the inner side 36 of the base 16. In some embodiments, the base 16 may include a plurality of base magnets. The base magnet 44 may be any conventional magnet. The base magnet 44 may be sized and shaped to fit within the base 16 of the frame assembly 12. For example, the base magnet 44 may be circular, or substantially circular, or substantially circular. The base magnet 44 may be located near the top 26 of the of the base 16.

The base magnet 44 has several functions. The first function of the base magnet 44 is to magnetically attract blade 14 to the base 16. This introduces increased stability when the blade 14 is being moved from the extended positions 24 to the retracted positions 22 and when the blade 14 is in use. The enhanced stability is important to allow for precision cutting when the blade holder assembly 10 is in use. This is particularly true when used to when scoring dough. In some embodiments, the base magnet 44 is the only magnet in the blade holder assembly 10. The base magnet 44 is strong enough to attach the blade 14 to the base 16 and the cover 18. An additional magnet may not be required.

The second function is to provide a magnetic surface to allow the base 16 of the frame assembly 12 to magnetically attract to metal surfaces. This feature allows for the magnetic blade holder assembly 10 to be mounted on any metal surface where the user can easily keep the magnetic blade holder assembly 10 in a place easily obtainable by the user.

The inner side 36 of the base 16 may also include a rib 46 and guide bars 48 configured to provide a guide for the blade 14 to fit within the base 16 and to allow for stability of the blade 14 when the blade 14 is moved from the retracted position 22 to the extended position 24. The rib 46 function as a stopper for the blade 14 so the blade 14 will not be able to come off base 16 if pulled from outside.

The rib 46 may be sized and shaped to receive a standard razor blade. For example, the rib 46 is an elongated substantially rectangular protrusion that is located near the top of the base 16 with the base magnet 44 surrounding the rib. In other embodiments, the rib 46 may be placed a center 50 of the base 16.

The guide bars 48 extend vertically from the top 26 of the base 16 toward the center 50 of the base 16. In some embodiments, the guide bars 48 extend past the center 50 of the base 16. A top portion of the guide bars is located near the opening 20 of the frame assembly 12. The guide bars 48 extend from near or around the top 26 of the base 16 to near or around the center 50 of the base 16. The guide bars 48 may be touching, or nearly touching, the wall portion 40 of the base 16. In some embodiments, the guide bars 48 do not touch the wall portion 40 of the base 16.

The purpose of the guide bars 48 is provide a slot 52 to receive the blade 14. The user can align the blade 14 between the guide bars 48 in order to secure the blade 14 within the base 16. The guide bars 48 also assist the user when move the blade 14 between multiple positions. The guide bars 48, along with the rib 46, provide a track for the blade 14 to slide along. When the blade 14 is in a fully retracted position 22 within the base, the blade 14 may fit entirely between the top portion of the base near the opening and the bottom of the guide bars 48. The guide bars 48 may be any desired size and shape to accommodate a corresponding blade 14. In some embodiments the guide bars 48 have a length that is substantially similar to the length of the blade 14. The guide bars 48 may be made of the same material as the base.

The inner side 36 of the base 16 also includes a central projection 54 located between the guide bars 48. The central projection 54 is sized to support the blade 14. The blade 14 is placed on the central projection 54 and aligned between the guide bars 48. The central projection 54 may be any desired size and shape. In some embodiments, the central projection 54 has a oval shape. In other embodiments, the central projection 54 is substantially circular.

The base 16 may further include a bottom aperture 56 near the bottom 28 of the base 16 near the wall portion 40 of the base 16. The bottom aperture 56 may be sized and shaped to allow the user to place a finger in the second aperture 56 to separate the base 16 from the cover 18 in order to access the blade 14. In some embodiments, the bottom aperture 56 is substantially circular, or substantially rectangular. In other embodiments, the base 16 may be separated from the cover 18

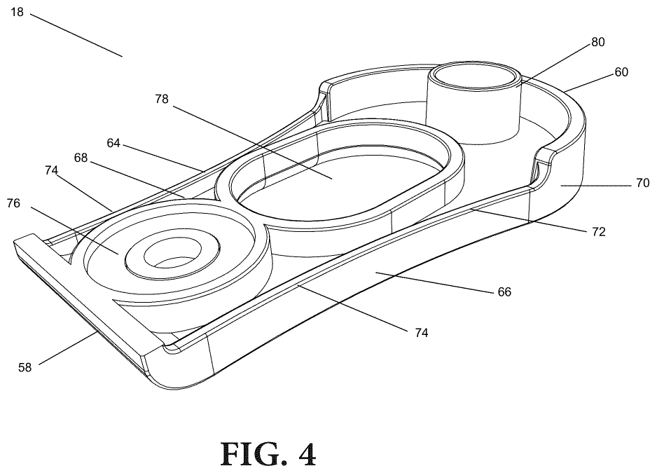

Referring to FIG. 4, the cover 18 has a top 58, bottom 60, center 62, first side 64, and second side 66. Additionally, the cover 18 has an inner side 68 and an outer side 70. The inner side 68 having a wall portion 72 that extends along an outer edge 74 of the cover 18. The wall portion 72 is configured to secure the cover 18 to the base 16. The wall portion 72 of the cover 18 may extend along the entire bottom 60 of the cover 18. In some embodiments, the wall portion extends further than the bottom of the cover 18 to include along the outer edge between the first side, and second side of the cover 18. When the cover 18 is smaller than the base, the wall portion of the cover 18 is sized to fit within the wall portion of the base.

The inner side 68 of the cover 18 may include at least one cover magnet 76 located on the inner side 68 of the cover 18. In some embodiments, the cover 18 may include a plurality of cover magnets 76. The cover magnet 76 may be any conventional magnet. The cover magnet 76 may be sized and shaped to fit within the cover 18 of the frame assembly 12, and to correspond with the base magnet. For example, if the over magnet is circular, the cover magnet 76 is also substantially circular. The cover magnet 76 may be located near the top 58 of the cover 18. When in use, the cover magnet 76 magnetically attracts to the base magnet 44. This causes the cover 18 and the base 16 to attach to form the frame assembly 12.

The cover magnet 76 has two additional functions. The first function of the cover magnet 76 is to magnetically attract the cover 18 to the blade 14. This introduces increased stability when the blade 14 is being moved from one of the extended positions 24 to one of the retracted positions 22 and when the blade 14 is in use. The second function is to provide a magnetic surface to allow the base 16 of the frame assembly 12 to magnetically attract to metal surfaces. This feature allows for the magnetic blade holder assembly 10 to be mounted on any metal surface where the user can easily keep the magnetic blade holder assembly 10 in a place easily obtainable by the user.

In some embodiments, the cover magnet 76 is not mandatory as the cover 18 maybe attached to the base 16 by other means like plastic snaps and the base magnet 44 is enough to hold the blade 14 and to hold the magnetic blade holding assembly 10 to a metal surface when storing.

The inner side 68 of the cover 18 also includes a central aperture 78 configured to correspond to the central projection 54 of the base 16. The central aperture 78 allows the user to control the movement of the blade 14 without having to remove the cover 18 from the base 16. The user may place a finger, preferably a thumb, though the central aperture 78 of the cover 18 to access the blade 14. The central aperture 78 may be any desired size and shape. In some embodiments, the shape of the central aperture 78 is substantially similar to the shape of the central projection 54 of the base 16. In other embodiments, the central aperture 78 has a oval shape. In other embodiments, the central aperture 78 is substantially circular.

The inner side 68 of the cover 18 further includes a boss 80 near the bottom 60 of the cover 18 and near the wall portion of the cover. The boss 80 is sized and shaped to allow it to fit within the bottom aperture 56 of the base, thus securing the cover 18 to the base. The user may place a finger in the bottom aperture 56, push the boss 80 to disengage the boss 80 from the bottom aperture 56 and separate the base 16 from the cover 18 in order to access the blade 14. In some embodiments, the boss 80 is substantially circular.

The magnetic blade holder assembly 10 may be manufactured using any conventional manufacturing process.

The magnetic blade holder assembly 10 can be sized to be used to hold different types of blades. Preferably, the magnetic blade holder assembly 10 is used with a standard sized razor blade. The user may use the blade 14 in any application, including scoring dough prior to baking.

To insert a new blade 14, the user may press the boss 80 on the cover 18. This will rise up the cover 18 and allow the boss 80 to disengage from the bottom aperture 56. The cover 18 can then be disconnected from the base 16.

The user takes the new blade 14 and place it between the guide bars 48, on the central projection 54. The blade 14 will be held in place on the base 16 by a magnetic connection between the blade 14 the base magnet. The cover 18 is placed on the base 16 such that the cover magnet 76 and the base magnet 44 is aligned with the cover magnet 76. The attractive force of the cover magnet 76 and the base magnet 44 secures the cover 18 to the base.

Once secured within the frame assembly 12, the user can move the blade 14 between one of the retracted position 22 and the one of the extended position 24 by inserting a finger into the central aperture 78 of the cover 18, and using the finger to move the blade 14.

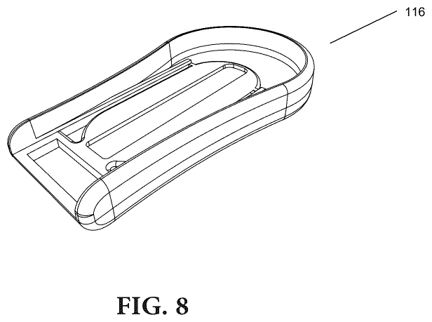

The blade 14 can be removed by pressing a finger into the central aperture 78 of the cover 18 and pushing the boss 80 until the boss 80 disengages from the bottom aperture 56. The blade 14 out is done by pressing and moving the blade 14 out with the thumb FIG. 8. The unit allow full control on the length of the exposed blade 14.

The magnetic blade holder assembly 10 can be magnetized to any metal surface for storing while not in use.

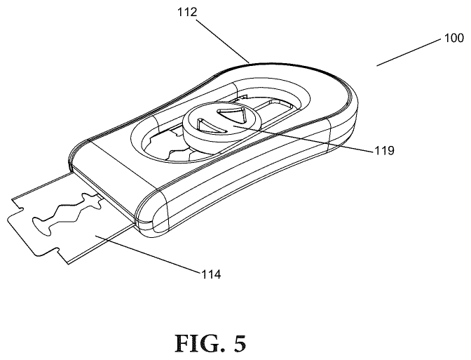

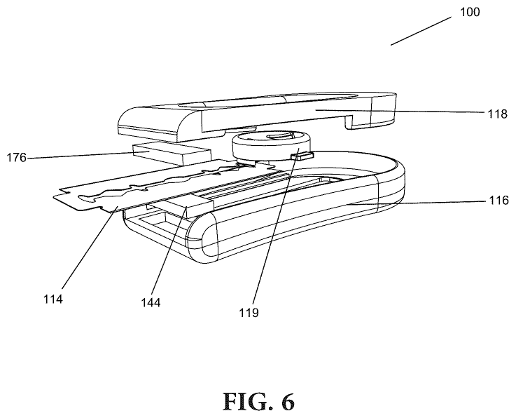

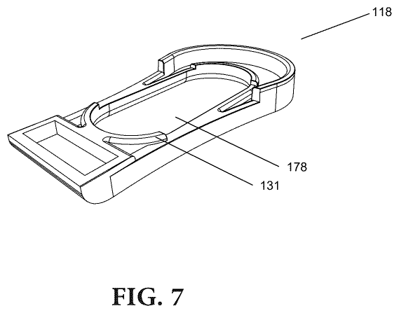

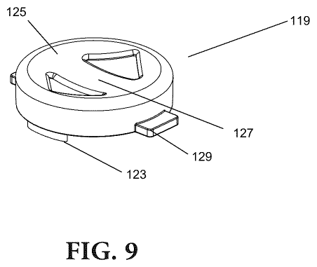

A second embodiment is illustrated in FIGS. 5-9 and is the same as the first embodiment except as described below.

In the second embodiment, a magnetic blade holder assembly 100 includes a frame 112, a blade 114, a base 116, and a cover 118. The magnetic blade holder assembly 100 further includes at least one magnet 144. The magnetic blade holder assembly 100 further includes a small knob 119. The knob 119 is sized to fit within the central aperture 178 of the cover 118. The knob 119 may also be made from any suitable material, including but not limited to, the same material of the frame 112.

An inner edge 121 of the knob 119 includes a projection 123 that is sized to fit into blade 114. An outer edge 125 of the knob 119 includes a depression 127 that is an ergonomic shape to fit a finger tip of the user. The knob 119 further includes at least one outer projection 129. The at least one outer projection 129 fits along an outer edge 131 of the central aperture 178. The function of the knob 119 is to allow the user easy access to the blade 114. The knob 119 importantly allows the user to move the blade from one of the retracted positions 122 to one of the extended positions 124.

The knob 119 is placed within the frame 112 such that the projection 123 is securely placed within the blade 114. When the cover 118 is aligned with the base 116, the outer projections 129 align with the outer edge 131 of the central aperture 178.

1. A magnetic blade holder, comprising:
a frame having a base and a cover;
a blade housed within the frame;
a first magnet attached to an inner side of the base; and
a second magnet attached to an inner side of the cover, wherein the cover is attached to the base when the first magnetic becomes magnetically attracted to the second magnet, and wherein the blade is housed within the frame between the base and the cover.

2. The magnetic blade holder of claim 1, wherein the cover includes a central aperture extending from the inner side of the cover to an outer side of the cover.

3. The magnetic blade holder of claim 2, wherein the central aperture facilitates removal of the cover from the base.

4. The magnetic blade holder of claim 2, wherein the blade is moveable through the central aperture.

5. The magnetic blade holder of claim 1, wherein the base includes a rib configured to secure the blade.

6. The magnetic blade holder of claim 5, wherein the frame comprises an opening between the base and the cover.

7. The magnetic blade holder of claim 6, wherein the blade moves vertically along the rib.

8. The magnetic blade holder of claim 7, wherein the blade passes along the rib through an opening of the frame to at least one extended position.

9. The magnetic blade holder of claim 8, wherein the blade is moved from the at least one extended position to a retracted position.

10. The magnetic blade holder of claim 1, wherein the blade is a disposable razor blade.

11. The magnetic blade holder of claim 1, wherein the blade is a double edged blade.

12. A method of scoring dough using a magnetic blade holder, the method comprising:
Providing a magnetic blade holder comprising
a frame having a base and a cover;
a first magnet attached to an inner side of the base; and
a second magnet attached to an inner side of the cover, wherein a blade is housed within the frame between the base and the cover;
passing the blade through an opening in the frame to at least one extended position;
marking the dough with the blade to create a pattern;
retracting the blade from the at least one extended position to a retracted position.

13. The method of claim 12, further comprising: removing the blade by pushing a cen on the cover to disengage the cover from the base.

14. The method of claim 12, further comprising: inserting a finger into an aperture on the cover to disengage the cover from the base.

15. The method of claim 12, further comprising: manually sliding the blade out from the base.

16. The method of claim 12, wherein the cover is attached to the base when the first magnetic is magnetically attracted to the second magnet.

17. The method of claim 12, wherein the blade is razor blade.

18. The method of claim 12, wherein the blade is a double-edged blade.

19. The method of claim 12, wherein the blade is secured to a rib in an interior of the frame.

20. The method of claim 15, wherein the blade moves vertically along the rib.
